(19) United States
(12) Patent Application Publication
(10) Pub. No.: US 2008/0040320 A1
(43) Pub. Date: Feb. 14, 2008

(54) METHOD AND SYSTEM FOR FILTERING DATA

(76) Inventors: Richard D. Dettinger, Rochester, MN (US); Frederick A. Kulack, Rochester, MN (US); Shannon E. Wenzel, Colby, WI (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/463,959

(22) Filed: Aug. 11, 2006

(51) Int. Cl. G06F 17/30

(52) U.S. Cl. 707/3

(57) ABSTRACT

A method, system and article of manufacture for managing execution of an abstract query against an underlying database. One embodiment comprises receiving an abstract query against one or more databases having physical data and receiving a user-selection specifying how to apply an abstract filter for filtering data. The abstract query is defined using logical fields of an abstraction model that models physical data of the database(s). If the abstract filter should be applied to the abstract query, the abstract query is submitted to a runtime unit configured to (i) modify the abstract query on the basis of the abstract filter, and (ii) transform the modified abstract query into a physical query suitable for execution against the one or more databases to determine a result set. As a result of executing the physical query, the result set containing data from the one or more databases is received.

### CROSS-REFERENCE TO RELATED APPLICATIONS

This application is related to the following commonly owned patent: U.S. Pat. No. 6,996,558 entitled “APPLICATION PORTABILITY AND EXTENSIBILITY THROUGH DATABASE SCHEMA AND QUERY ABSTRACTION”. This related patent is herein incorporated by reference in its entirety.

### BACKGROUND OF THE INVENTION

1. Field of the Invention

The present invention generally relates to data processing and, more particularly, to processing of abstract queries and/or query results.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find out the location of data, and so forth.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

Unfortunately, generating queries using SQL may require a detailed understanding of the possibly complex physical layout of the underlying database and interpretation of cryptic field names. For some applications, to facilitate the query building process, an abstraction model may be utilized that, in effect, hides some of the complexities of the underlying database's physical layout from users. The abstraction model may include logical fields with recognizable names that map to corresponding physical fields of the underlying database. “Abstract” queries may be generated containing conditions based on the logical fields. Upon issuance, the logical fields of an abstract query may be mapped to corresponding physical fields to create a physical or “concrete” query. For some applications, abstract queries may be saved, allowing subsequent users to reuse the saved abstract queries without having to generate their own. The concepts of data abstraction and abstract queries are described in detail in the commonly owned, co-pending application Ser. No. 10/083,075, entitled “APPLICATION PORTABILITY AND EXTENSIBILITY THROUGH DATABASE SCHEMA AND QUERY ABSTRACTION”, filed Feb. 26, 2002, which is herein incorporated by reference in its entirety.

Abstract queries often contain a conditional element (e.g., a WHERE clause in a corresponding SQL statement) in which a logical field is used within an expression with a comparison operator. As described in the related application Ser. No. 10/083,075, logical fields are typically mapped to a particular physical field in a physical database. For instance, if the physical database was implemented as a relational database, a particular logical field would be mapped to a particular column within a relational table.

While abstraction makes working with the data easy and efficient, in certain instances there remains a need to support users in selecting required information from underlying databases and/or query results more easily and efficiently. For instance, assume a researcher who performs a statistical analysis in a hospital to determine information with respect to hemoglobin values of myeloid leukemia patients. To this end, the researcher issues a corresponding abstract query against the underlying database(s), whereby a query result is obtained having a multiplicity of data records related to patients of the hospital. The corresponding abstract query can be created by the researcher or retrieved from memory prior to execution. Assume now that the researcher reviews a portion of the multiplicity of data records and notes that some of the patients are chronic myeloid leukemia patients. Assume further that the chronic myeloid patients have hemoglobin values that are in another range of values than the hemoglobin values of the non-chronic myeloid leukemia patients and that the researcher now decides to investigate in more detail on the non-chronic myeloid leukemia patients. In order to simplify the further investigation, the researcher wants to remove all data records related to chronic myeloid patients from display.

In order to remove the data records related to the chronic myeloid leukemia patients from display, the researcher needs to re-formulate and re-execute the corresponding abstract query against the underlying database(s). Assuming that the underlying database(s) is voluminous and includes a huge amount of data records, executing the abstract query may already have required a considerable amount of processor resources and time. Accordingly, re-executing the abstract query would again require a considerable amount of processor resources and time and is, thus, inefficient and time-consuming.

Therefore, there is a need for an efficient technique for selecting data records from an underlying database for presentation in a query result.

### SUMMARY OF THE INVENTION

The present invention is generally directed to a method, system and article of manufacture for query processing and, more particularly, for processing of abstract queries and/or query results.

One embodiment provides a computer-implemented method of managing execution of an abstract query against an underlying database. The method comprises receiving an abstract query against one or more databases having physical data. The abstract query is defined using logical field definitions defined in an abstraction model that models the physical data in a manner making a schema of the physical data transparent to a user of the abstraction model. The method further comprises receiving a user-selection specifying how to apply an abstract filter for filtering data. If the received user-selection specifies application of the abstract filter to an obtained result set, the abstract query is executed to determine a first result set containing data from the one or more databases. Then, the determined first result set is filtered on the basis of the abstract filter, whereby selected data is discarded from the first result set. If the received user-selection specifies application of the abstract filter to the abstract query, the abstract query is modified on the basis of the abstract filter. Then, the modified abstract query is executed to determine a second result set containing data from the one or more databases.

Another embodiment provides a computer-implemented method of managing execution of an abstract query against an underlying database. The method comprises receiving an abstract query against one or more databases having physical data, the abstract query being defined using logical field definitions defined in an abstraction model that models the physical data in a manner making a schema of the physical data transparent to a user of the abstraction model. The method further comprises receiving a user-selection specifying how to apply an abstract filter for filtering data. If the received user-selection specifies application of the abstract filter to the abstract query, the abstract query is submitted to a runtime unit configured to (i) modify the abstract query on the basis of the abstract filter, and (ii) transform the modified abstract query into a first physical query suitable for execution against the one or more databases to determine a first result set. As a result of executing the first physical query, the first result set containing data from the one or more databases is received.

Still another embodiment provides a computer-implemented method of creating an abstract filter. The method comprises creating a generic conditional statement associating a parameterized logical field definition with a logical operator and a comparison value. The parameterized logical field definition defines a field placeholder for a logical field definition defined in an abstraction model that models underlying physical data in a manner making a schema of the physical data transparent to a user of the abstraction model. The method further comprises associating a filter name with the abstract filter that uniquely identifies the abstract filter. Then, the generic conditional statement is stored as the abstract filter using the filter name.

Still another embodiment provides a computer-readable medium containing a program which, when executed by a processor, performs a process of managing execution of an abstract query against an underlying database. The process comprises receiving an abstract query against one or more databases having physical data. The abstract query is defined using logical field definitions defined in an abstraction model that models the physical data in a manner making a schema of the physical data transparent to a user of the abstraction model. The process further comprises receiving a user-selection specifying how to apply an abstract filter for filtering data. If the received user-selection specifies application of the abstract filter to an obtained result set, the abstract query is executed to determine a first result set containing data from the one or more databases. Then, the determined first result set is filtered on the basis of the abstract filter, whereby selected data is discarded from the first result set. If the received user-selection specifies application of the abstract filter to the abstract query, the abstract query is modified on the basis of the abstract filter. Then, the modified abstract query is executed to determine a second result set containing data from the one or more databases.

Still another embodiment provides a computer-readable medium containing a program which, when executed by a processor, performs a process of managing execution of an abstract query against an underlying database. The process comprises receiving an abstract query against one or more databases having physical data, the abstract query being defined using logical field definitions defined in an abstraction model that models the physical data in a manner making a schema of the physical data transparent to a user of the abstraction model. The process further comprises receiving a user-selection specifying how to apply an abstract filter for filtering data. If the received user-selection specifies application of the abstract filter to the abstract query, the abstract query is submitted to a runtime unit configured to (i) modify the abstract query on the basis of the abstract filter, and (ii) transform the modified abstract query into a first physical query suitable for execution against the one or more databases to determine a first result set. As a result of executing the first physical query, the first result set containing data from the one or more databases is received.

Yet another embodiment provides a computer-readable medium containing a program which, when executed by a processor, performs a process of creating an abstract filter. The process comprises creating a generic conditional statement associating a parameterized logical field definition with a logical operator and a comparison value. The parameterized logical field definition defines a field placeholder for a logical field definition defined in an abstraction model that models underlying physical data in a manner making a schema of the physical data transparent to a user of the abstraction model. The process further comprises associating a filter name with the abstract filter that uniquely identifies the abstract filter. Then, the generic conditional statement is stored as the abstract filter using the filter name.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to create and execute database queries and to process query results, according to one embodiment of the invention;

FIGS. 3A-B are relational views of software components in one embodiment;

FIGS. 4-5 are flow charts illustrating the operation of a runtime component, in one embodiment;

FIG. 6 is a flow chart illustrating a method of creating an abstract filter according to one embodiment of the invention;

FIG. 7 is a screen shot illustrating creation of an exemplary abstract filter in one embodiment;

FIGS. 8A-B are flow charts illustrating a method of managing application of an abstract filter to an abstract query and/or a result set according to one embodiment of the invention;

FIG. 9 is a screen shot illustrating an exemplary query result;

FIG. 10 is a screen shot illustrating the exemplary query result of FIG. 9 from which null values were filtered;

FIG. 11 is a screen shot illustrating application of an abstract filter to a condition field of an abstract query in one embodiment;

FIG. 12 is a screen shot illustrating another exemplary query result;

FIG. 13 is a screen shot illustrating the exemplary query result of FIG. 12 from which low values were filtered; and

FIG. 14 is a flow chart illustrating application of an abstract filter to a result field of the exemplary query result of FIG. 12 in one embodiment.

### DETAILED DESCRIPTION OF THE PREFERRED EMBODIMENTS

### Introduction

The present invention is generally directed to a method, system and article of manufacture for query processing and, more particularly, for processing of abstract queries and/or query results. In general, queries such as SQL or XML queries are executed against one or more underlying databases. Typically, a database query includes one or more result fields specifying what data elements should be returned in a result set. A query also typically specifies conditions with condition fields used to evaluate whether a given element of data should be included in the result set. The result set includes the one or more result fields, each having data that was retrieved from the underlying database(s) for the result field according to the specified condition(s).

An abstract query is specified using one or more logical field definitions defined by a data abstraction model that models the physical data in the underlying database(s) in a manner making a schema of the physical data transparent to a user of the abstraction model. The logical field definitions are used for specification of result fields and condition fields of a given abstract query. The given abstract query is transformed into an executable query that can be executed against the underlying database/s), such as an SQL or XML query.

In one embodiment, an abstract filter can be applied to a given abstract query. More specifically, the abstract filter is applied to one or more result and/or condition fields of the given abstract query to filter selected data prior to outputting a corresponding result set for the given abstract query. Alternatively, an abstract filter can be applied to a result field of a displayed result set. By applying the abstract filter to the abstract query and/or the displayed result set, the selected data is discarded from output in the corresponding result set.

In one embodiment, an abstract filter is defined by a generic conditional statement associating a parameterized logical field definition with a comparison operator and a comparison value. The parameterized logical field definition defines a placeholder for a logical field definition of an underlying data abstraction model that models physical data in the underlying database(s). The placeholder can be replaced with a logical field definition used to define a result and/or condition field of the given abstract query or a result field of the displayed result set.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

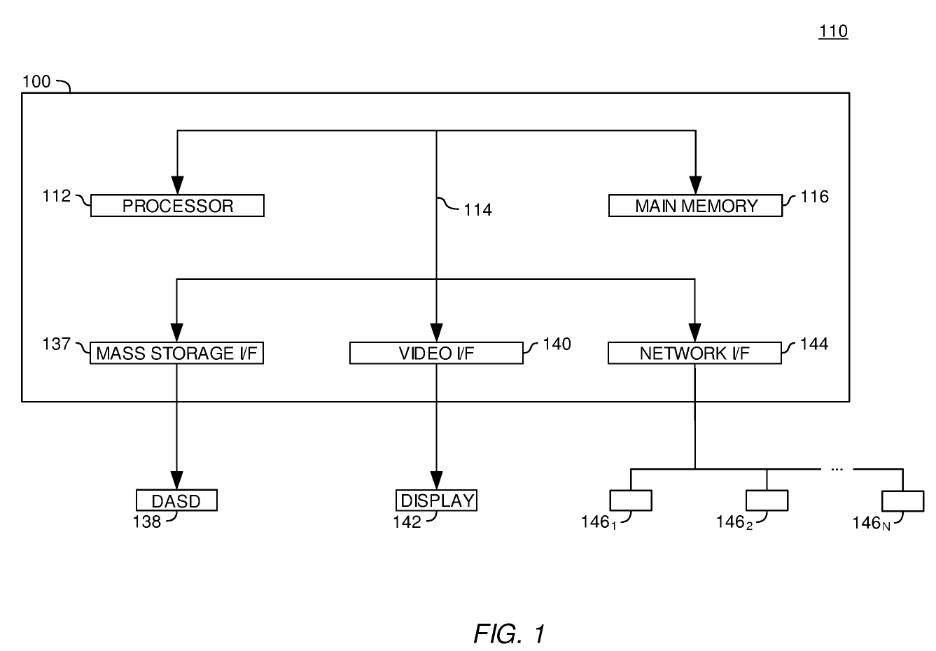

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 1 00 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to a plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Query Creation and Execution Environment

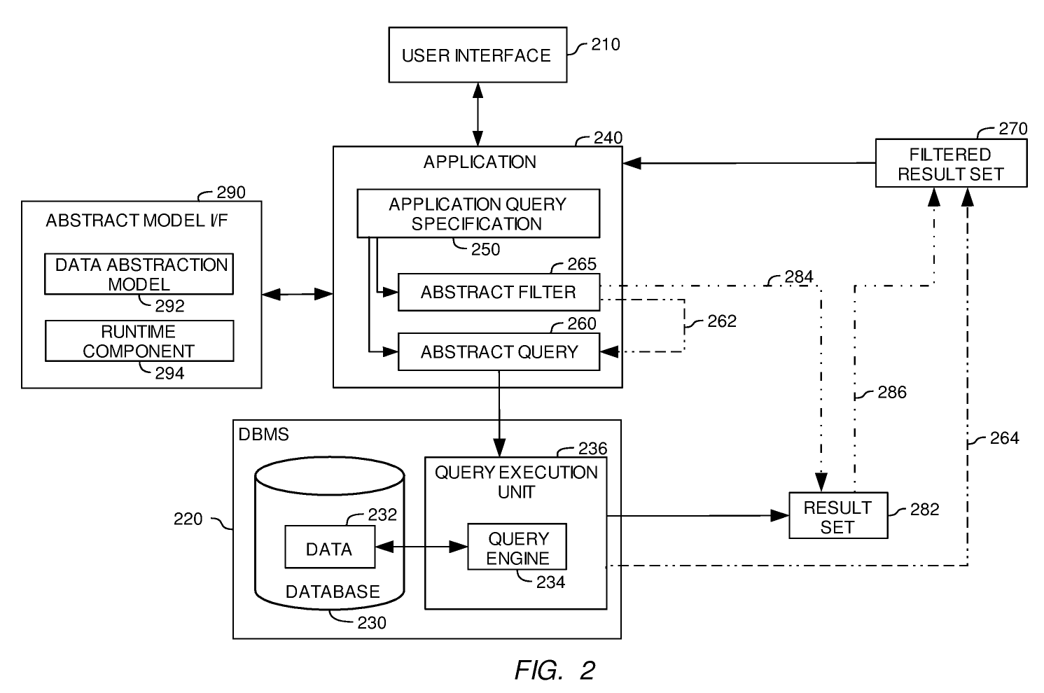

Referring now to FIG. 2, a relational view of software components in one embodiment is illustrated. The software components illustratively include a user interface 210, a DBMS 220, one or more applications 240 (only one application is illustrated for simplicity) and an abstract model interface 290. The abstract model interface 290 illustratively includes a data abstraction model 292 and a runtime component 294. The DBMS 220 illustratively includes a database 230 and a query execution unit 236 having a query engine 234.

The database 230 is shown as a single database having data 232, for simplicity. However, the database 230 can also be implemented by multiple databases which can be distributed relative to one another. Moreover, one or more databases can be distributed to one or more networked devices (e.g., networked devices 146 of FIG. 1). The database 230 is representative of any collection of data regardless of the particular physical representation of the data. A physical representation of data defines an organizational schema of the data. By way of illustration, the database 230 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of the data 232.

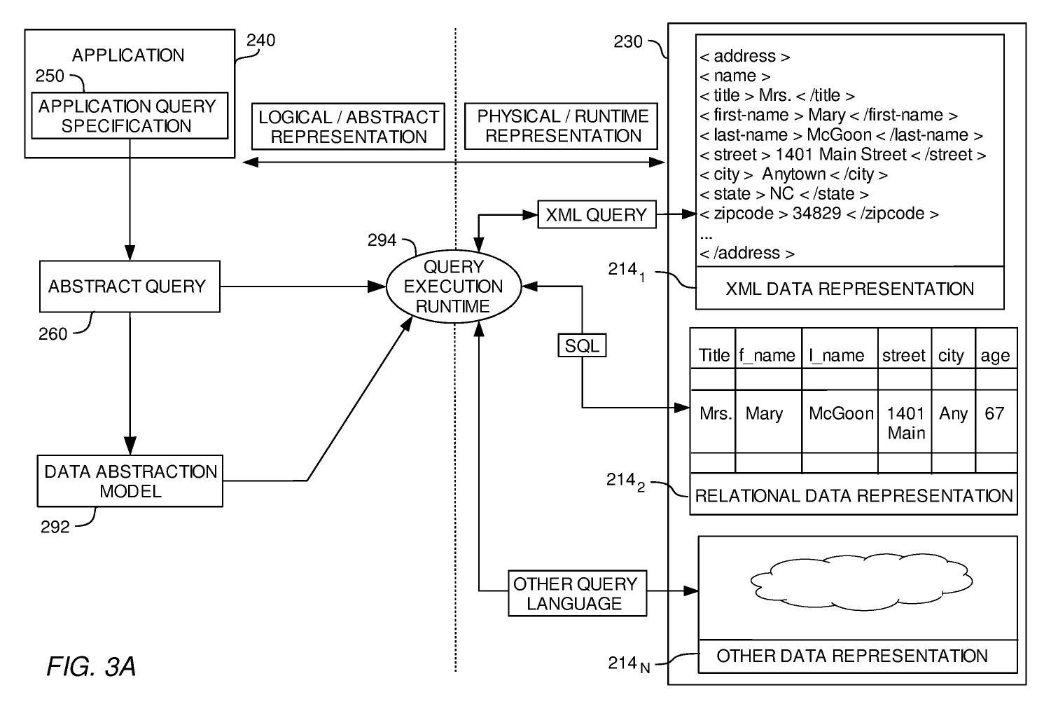

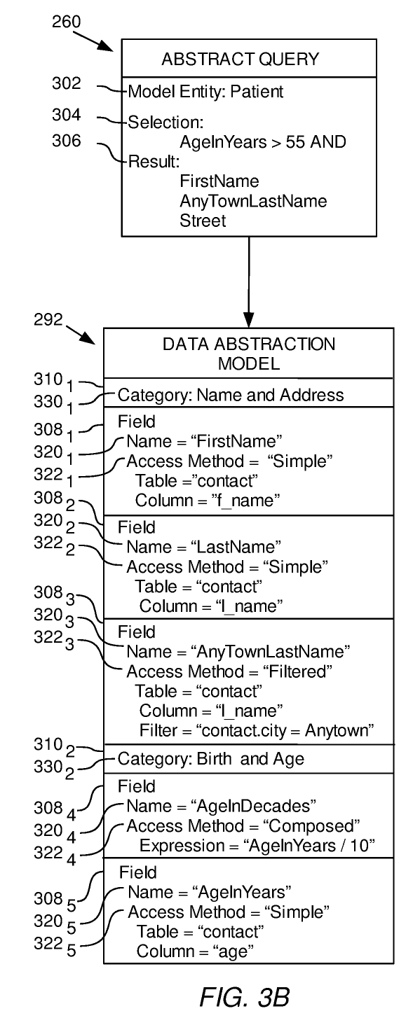

According to one aspect, the application 240 (and more generally, any requesting entity including, at the highest level, users) issues queries against the data 232 in the database 230. In general, the queries issued by the application 240 are defined according to an application query specification 250 and may be predefined (i.e., hard coded as part of the application 240) or generated in response to input (e.g., user input). The application query specification(s) 250 is further described below with reference to FIGS. 3-5.

Illustratively, the queries issued by the application 240 are created by users using the user interface 210, which can be any suitable user interface configured to create/submit queries. According to one aspect, the user interface 210 is a graphical user interface. However, it should be noted that the user interface 210 is only shown by way of example; any suitable requesting entity may create and submit queries against the database 230 (e.g., the application 240, an operating system or an end user). Accordingly, all such implementations are broadly contemplated.

In one embodiment, the requesting entity accesses a suitable database connectivity tool such as a Web application, an Open DataBase Connectivity (ODBC) driver, a Java® DataBase Connectivity (JDBC) driver or a Java® Application Programming Interface (Java® API) for creation of a query. A Web application is an application that is accessible by a Web browser and that provides some function beyond static display of information, for instance by allowing the requesting entity to query the database 230. An ODBC driver is a driver that provides a set of standard application programming interfaces to perform database functions such as connecting to the database 230, performing dynamic SQL functions, and committing or rolling back database transactions. A JDBC driver is a program included with a database management system (e.g., DBMS 220) to support JDBC standard access between the database 230 and Java® applications. A Java® API is a Java®-based interface that allows an application program (e.g., the requesting entity, the ODBC or the JDBC) that is written in a high-level language to use specific data or functions of an operating system or another program (e.g., the application 240).

In one embodiment, the queries issued by the application 240 are composed using the abstract model interface 290. Such queries are referred to herein as “abstract queries”. The abstract model interface 290 is further described below with reference to FIGS. 3-5. The abstract queries are transformed into a form consistent with the physical representation of the data 232 for execution against the database 230.

In the illustrated example, an abstract query 260 is created on the basis of logical fields defined by the data abstraction model 292. More specifically, the abstract query 260 is created by creating a results specification and, if required, selection criteria, as explained in more detail below with reference to FIGS. 3A-B. The results specification is defined by one or more result fields specifying what data elements should be returned from the data 232. The selection criteria is defined using one or more condition fields in corresponding query conditions that are configured to evaluate whether a given element of data should be returned. The result field(s) and the condition field(s) are defined using the logical fields of the data abstraction model 292.

In one embodiment, the abstract query 260 is translated by the runtime component 294 into a concrete (i.e., executable) query, such as an SQL or XML query. The executable query is submitted to the query execution unit 236 for execution. It should be noted that the query execution unit 236 illustratively only includes the query engine 234, for simplicity. However, the query execution unit 236 may include other components, such as a query parser and a query optimizer. A query parser is generally configured to accept a received query input from a requesting entity, such as the application(s) 240, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 230), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. The query optimizer may then forward the optimized executable query to the query engine 234 for execution. The optimized executable query is then executed by the query engine 234 against the data 232 of the database 230 to determine a result set 282 and/or a filtered result set 270 for the abstract query 260, as described in more detail below.

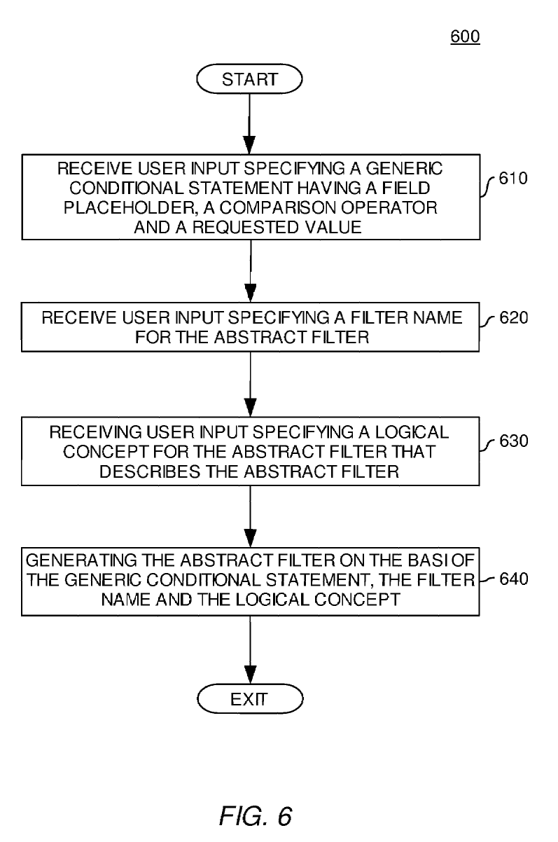

Illustratively, an abstract filter 265 is associated with the abstract query 260. The abstract filter 265 is configured to filter selected data elements from the data elements that should be returned for the abstract query 260 from the data 232. Enabling use of the abstract filter 265 provides a more flexible approach of selecting only required data elements from the database 230, as the abstract filter 265 can be applied to the abstract query 260 as well as to a corresponding query result (e.g., result set 282), as described in more detail below. An exemplary method for creation of an abstract filter is described in more detail below with reference to FIG. 6.

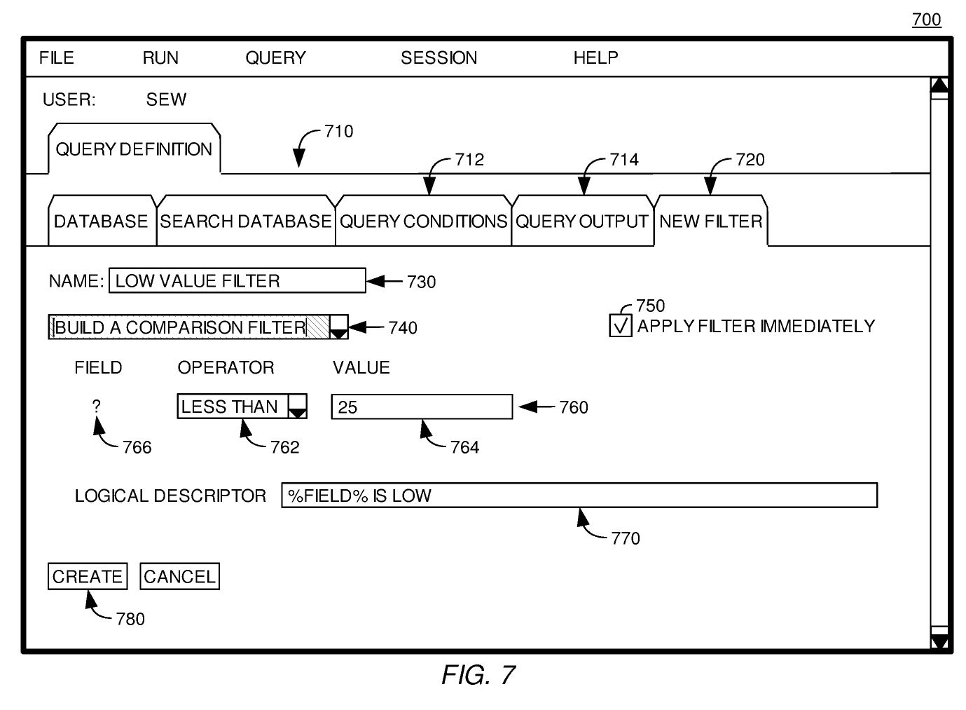

In one embodiment, the abstract filter 265 is created by a user using a suitable user interface configured to create abstract filters, e.g., the user interface 210. By way of example, the user interface 210 can be configured to display a graphical user interface that guides the user through creation of the abstract filter 265. An exemplary graphical user interface is illustrated in FIG. 7.

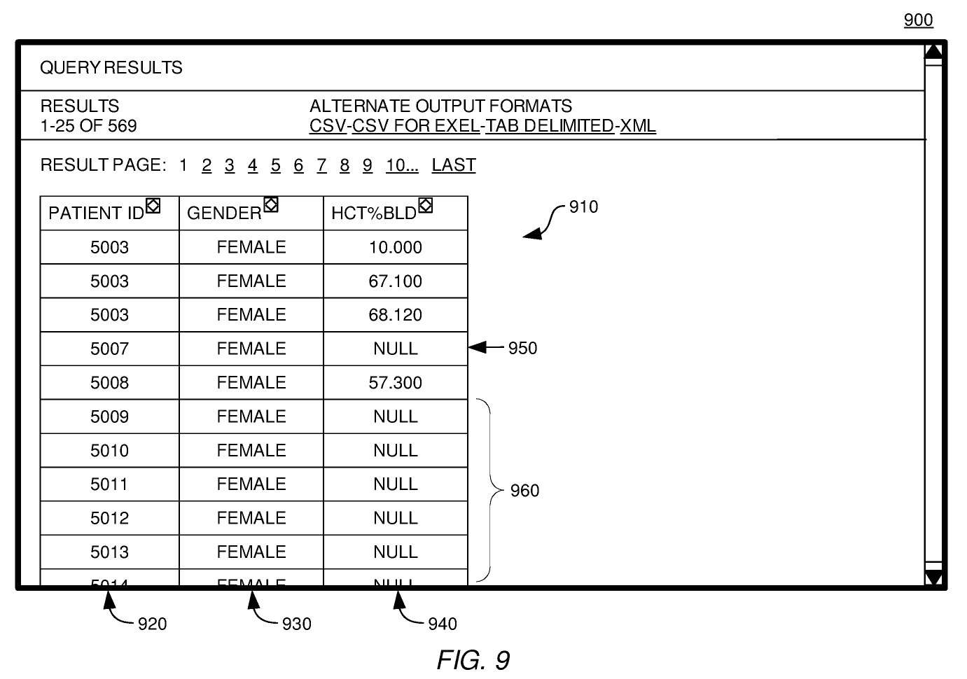

In one embodiment, the abstract filter 265 is applied to the abstract query 260 prior to transformation of the abstract query 260 into a corresponding executable query, as illustrated by a dashed arrow 262. More specifically, the abstract filter 265 is applied to at least one result field and/or at least one condition field of the abstract query 260. Accordingly, filtering of the selected data elements occurs at query execution runtime. In other words, when the query engine 234 executes the corresponding executable query against the data 232, the selected data elements are filtered according to the abstract filter 265. Thus, the selected data elements are discarded from output and the filtered result set 270 is determined, as illustrated by a dashed arrow 264. The filtered result set 270 is output to the application(s) 240 for further processing. For instance, the filtered result set 270 is displayed to a user using the user interface 210. Application of an abstract filter to a result field and/or a condition field of an abstract query is described in more detail below with reference to FIGS. 9-13.

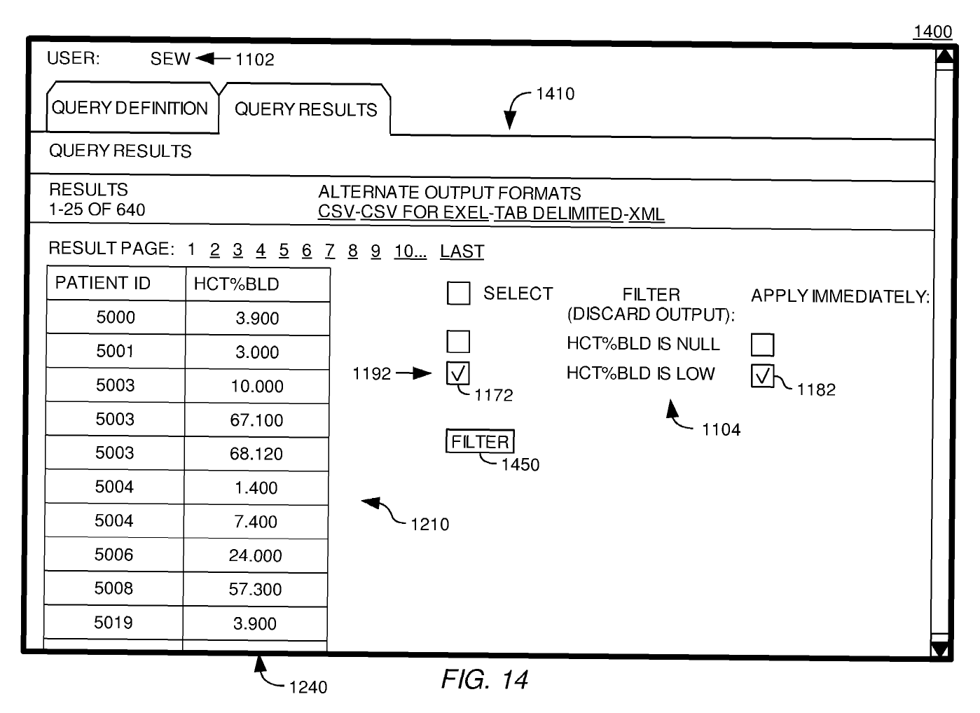

In one embodiment, the abstract query 250 is transformed into an executable query, as described above. The executable query is then executed against the data 232 to determine a result set 282 having data for the result fields of the abstract query 260. The result set 282 is output to the application(s) 240 for further processing. For instance, the result set 282 is displayed to the user using the user interface 210. The user may thus decide to apply the abstract filter 265 to one or more of the result fields of the result set 282, as illustrated by a dashed arrow 284. In this case, the result set 282 is filtered according to the abstract filter 265 to determine the filtered result set 270. The filtered result set 270 is then returned to the application(s) 240, as described above. Application of an abstract filter against a result field of a result set is described in more detail below with reference to FIG. 14.

### Logical/Runtime View of Environment

FIGS. 3A-3B show an illustrative relational view of software components in one embodiment. According to one aspect, the software components are configured for query execution management and illustratively include the application 240, the data abstraction model 292, the runtime component 294 and the database 230 of FIG. 2. By way of example, the database 230 includes a plurality of exemplary physical data representations 214₁, 214₂, . . . 214_{N} for the data 232 of FIG. 2.

As noted above with reference to FIG. 2, the application 240 issues the abstract query 260 against the database 230. In one embodiment, the application 240 issues the query 260 as defined by the application query specification 250. The abstract query 260 is composed according to logical fields rather than by direct reference to underlying physical data entities in the database 230. The logical fields are defined by the data abstraction model 292 which generally exposes information as a set of logical fields that may be used within a query (e.g., the abstract query 290) issued by the application 240 to specify criteria for data selection and specify the form of result data returned from a query operation. Furthermore, the abstract query 260 may include a reference to an underlying model entity that specifies the focus for the abstract query 260 (model entity 302). In one embodiment, the application query specification 250 may include both criteria used for data selection (selection criteria 304) and an explicit specification of the fields to be returned (return data specification 306) based on the selection criteria 304, as illustrated in FIG. 3B.

The logical fields of the data abstraction model 292 are defined independently of the underlying data representation (i.e., one of the plurality of exemplary physical data representations 214_{1-N}) being used in the database 230, thereby allowing queries to be formed that are loosely coupled to the underlying data representation. More specifically, a logical field defines an abstract view of data whether as an individual data item or a data structure in the form of, for example, a database table. As a result, abstract queries such as the query 260 may be defined that are independent of the particular underlying data representation used. Such abstract queries can be transformed into a form consistent with the underlying physical data representation 214_{1-N} for execution against the database 230. By way of example, the abstract query 260 is translated by the runtime component 294 into an executable query which is executed against the database 230 to determine a corresponding result set (e.g., result set 282 and/or filtered result set 270 of FIG. 2) for the abstract query 260.

In one embodiment, illustrated in FIG. 3B, the data abstraction model 292 comprises a plurality of field specifications 308₁, 308₂, 308₃, 308₄ and 308₅ (five shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅ (collectively, field name 320) and an associated access method attribute 322₁, 322₂, 322₃, 322₄, 322₅ (collectively, access methods 322). Each attribute may have a value. For example, logical field name attribute 320₁, has the value “FirstName” and access method attribute 322₁, has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “f_name”. Accordingly, assuming an underlying relational database schema in the present example, the values of data location metadata “Table” and “Column” point to a table “contact” having a column “f_name”.

In one embodiment, groups (i.e. two or more) of logical fields may be part of categories. Accordingly, the data abstraction model 292 includes a plurality of category specifications 310₁ and 310₂ (two shown by way of example), collectively referred to as the category specifications. In one embodiment, a category specification is provided for each logical grouping of two or more logical fields. For example, logical fields 308₁₋₃ and 308₄₋₅ are part of the category specifications 310₁ and 310₂, respectively. A category specification is also referred to herein simply as a “category”. The categories are distinguished according to a category name, e.g., category names 330₁ and 330₂ (collectively, category name(s) 330). In the present illustration, the logical fields 308₁₋₃ are part of the “Name and Address” category and logical fields 308₄₋₅ are part of the “Birth and Age” category.

The access methods 322 generally associate (i.e., map) the logical field names to data in the database (e.g., database 230 of FIG. 2). As illustrated in FIG. 3A, the access methods associate the logical field names to a particular physical data representation 214_{1-N} in the database. By way of illustration, two data representations are shown, an XML data representation 214₁, and a relational data representation 214₂. However, the physical data representation 214_{N} indicates that any other data representation, known or unknown, is contemplated. In one embodiment, a single data abstraction model 292 contains field specifications (with associated access methods) for two or more physical data representations 214_{1-N}. In an alternative embodiment, a different single data abstraction model 292 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂ and 308₅ exemplify simple field access methods 322₁, 322₂, and 322₅, respectively. Simple fields are mapped directly to a particular entity in the underlying physical representation (e.g., a field mapped to a given database table and column). By way of illustration, as described above, the simple field access method 322₁ shown in FIG. 3B maps the logical field name 320₁ (“FirstName”) to a column named “f_name” in a table named “contact”. The field specification 308₃ exemplifies a filtered field access method 322₃. Filtered fields identify an associated physical entity and provide filters used to define a particular subset of items within the physical representation. An example is provided in FIG. 3B in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 3B the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 292 shown in FIG. 3B are representative of logical fields mapped to data represented in the relational data representation 214₂ shown in FIG. 3A. However, other instances of the data abstraction model 292 map logical fields to other physical representations, such as XML.

An illustrative abstract query corresponding to the abstract query 260 shown in FIG. 3B is shown in Table I below. By way of illustration, the illustrative abstract query is defined using XML. However, any other language may be used to advantage.

TABLE I
ABSTRACT QUERY EXAMPLE

| | |
|---|---|
| 001 | <?xml version=“1.0”?> |
| 002 | <!--Query string representation: (AgeInYears > “55”--> |
| 003 | <QueryAbstraction> |
| 004 | <Selection> |
| 005 | <Condition internalID=“4”> |
| 006 | <Condition field=“AgeInYears” operator=“GT” value=“55” |
| 007 | internalID=“1”/> |
| 008 | </Selection> |
| 009 | <Results> |
| 010 | <Field name=“FirstName”/> |
| 011 | <Field name=“AnyTownLastName”/> |
| 012 | <Field name=“Street”/> |
| 013 | </Results> |
| 014 | <Entity name=“Patient” > |
| 015 | <EntityField required=“Hard” > |
| 016 | <FieldRef name=“data://Demographic/Patient ID” /> |
| 017 | <Usage type=“query” /> |
| 018 | </EntityField> |
| 019 | </Entity> |
| 020 | </QueryAbstraction> |

Illustratively, the abstract query shown in Table I includes a selection specification (lines 004-008) containing selection criteria and a results specification (lines 009-013). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. The abstract query shown in Table I further includes a model entity specification in lines 014-019 which specifies that the query is a query of the “patient” model entity.

An illustrative data abstraction model (DAM) corresponding to the data abstraction model 292 shown in FIG. 3B is shown in Table II below. By way of illustration, the illustrative Data Abstraction Model is defined using XML. However, any other language may be used to advantage.

TABLE II
DATA ABSTRACTION MODEL EXAMPLE

| | |
|---|---|
| 001 | <?xml version=“1.0”?> |
| 002 | <DataAbstraction> |
| 003 | <Category name=“Name and Address”> |
| 004 | <Field queryable=“Yes” name=“FirstName” |
| | displayable=“Yes”> |
| 005 | <AccessMethod> |
| 006 | <Simple columnName=“f_name” |
| | tableName=“contact”></Simple> |
| 007 | </AccessMethod> |
| 008 | </Field> |
| 009 | <Field queryable=“Yes” name=“LastName” |
| | displayable=“Yes”> |
| 010 | <AccessMethod> |
| 011 | <Simple columnName=“I_name” |
| | tableName=“contact”></Simple> |
| 012 | </AccessMethod> |
| 013 | </Field> |
| 014 | <Field queryable=“Yes” name=“AnyTownLastName” |
| | displayable=“Yes”> |
| 015 | <AccessMethod> |
| 016 | <Filter columnName=“I_name” tableName=“contact” |
| 017 | Filter=”contact.city=Anytown”> </Filter> |
| 018 | </AccessMethod> |
| 019 | </Field> |
| 020 | </Category> |
| 021 | <Category name=“Birth and Age”> |
| 022 | <Field queryable=“Yes” name=“AgeInDecades” |
| | displayable=“Yes”> |
| 023 | <AccessMethod> |
| 024 | <Composed columnName=“age” tableName=“contact” |
| 025 | Expression=”columnName/10”> </Composed> |
| 026 | </AccessMethod> |
| 027 | </Field> |
| 028 | <Field queryable=“Yes” name=“AgeInYears” |
| | displayable=“Yes”> |
| 029 | <AccessMethod> |
| 030 | <Simple columnName=“age” |
| | tableName=“contact”></Simple> |
| 031 | </AccessMethod> |
| 032 | </Field> |
| 033 | </Category> |
| 034 | </DataAbstraction> |

By way of example, note that lines 004-008 correspond to the first field specification 308₁ of the DAM 292 shown in FIG. 3B and lines 009-013 correspond to the second field specification 308₂.

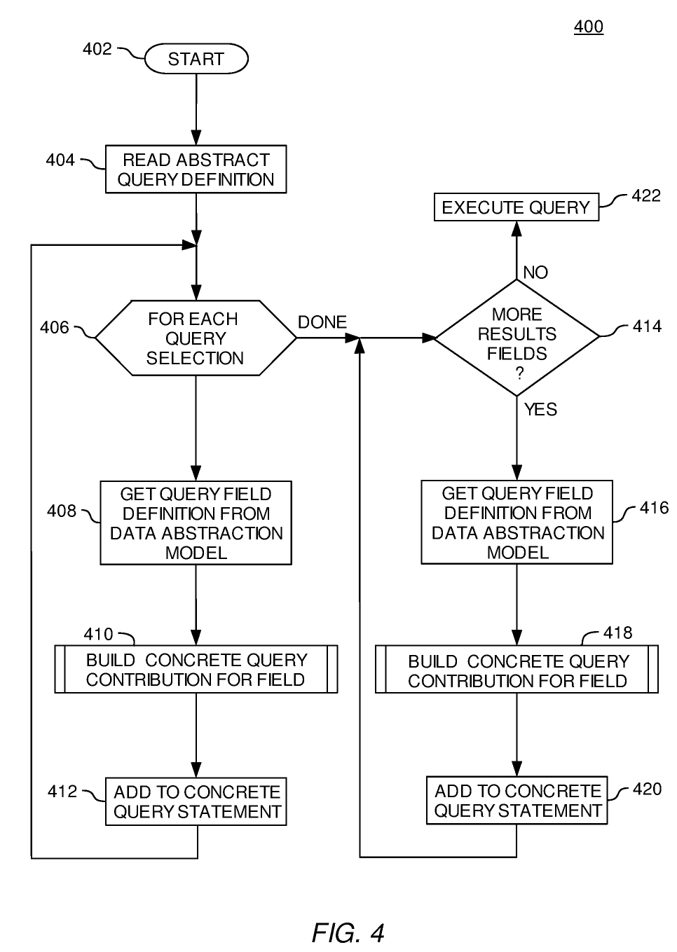

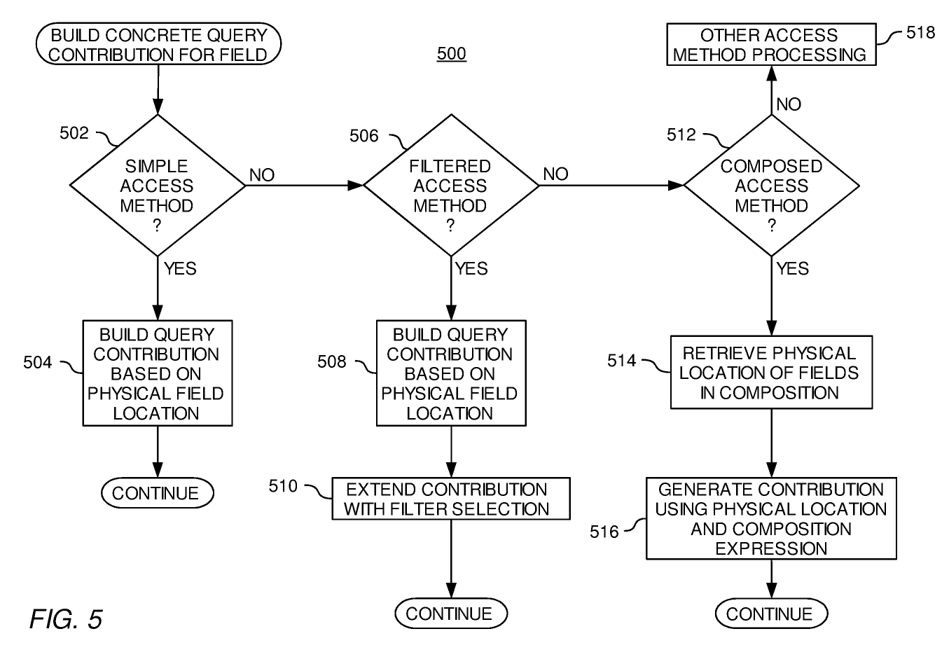

As was noted above, an executable query can be generated on the basis of the abstract query of Table I for execution against an underlying database (e.g., database 230 of FIG. 3A). An exemplary method for generating an executable query on the basis of an abstract query is described below with reference to FIGS. 4-5.

### Generating an Executable Query From an Abstract Query

Referring now to FIG. 4, an illustrative runtime method 400 exemplifying one embodiment of generating an executable query (also referred to hereinafter as “concrete” query) on the basis of an abstract query (e.g., abstract query 260 of FIG. 2) using the runtime component 294 of FIG. 2 is shown. The method 400 is entered at step 402 when the runtime component 294 receives the abstract query (such as the abstract query shown in Table I) as input. At step 404, the runtime component 294 reads and parses the abstract query and locates individual selection criteria (e.g., selection criteria 304 of FIG. 3B) and desired result fields (e.g., return data specification 306 of FIG. 3B).

At step 406, the runtime component 294 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 294 uses the field name from a selection criterion of the abstract query to look up the definition of the field in the data abstraction model 292. As noted above, the field definition includes a definition of the access method used to access the data structure associated with the field. The runtime component 294 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 230 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 294 identifies the information to be returned as a result of query execution. As described above, in one embodiment, the abstract query defines a list of result fields, i.e., a list of logical fields that are to be returned as a result of query execution, referred to herein as a results specification. A results specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 294 looks up a result field name (from the result specification of the abstract query) in the data abstraction model 292 and then retrieves a result field definition from the data abstraction model 292 to identify the physical location of data to be returned for the current logical result field. The runtime component 294 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 422, where the concrete query is executed.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 as described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Creating an Abstract Filter

Referring now to FIG. 6, one embodiment of a method 600 for creating an abstract filter (e.g., abstract filter 265 of FIG. 2) on the basis of an underlying data abstraction model (e.g., data abstraction model 292 of FIG. 2) is illustrated. At least a portion of the steps of method 600 can be performed using the user interface 210 of FIG. 2.

Method 600 starts at step 610, where a generic conditional statement having a field placeholder, a logical operator and a requested value expression is created for the abstract filter. The generic conditional statement defines a filter operation that is to be performed by the abstract filter to filter selected data elements from data elements that are to be returned in response to execution of a given abstract query (e.g., abstract query 260 of FIG. 2).

The field placeholder refers to at least one logical field definition of the underlying data abstraction model. Accordingly, if the at least one logical field definition is used as result and/or condition field in the given abstract query, the field placeholder can be replaced with the result and/or condition field. Thus, the abstract filter can be applied to the abstract query. Furthermore, if the at least one logical field definition occurs as a result field in a corresponding result set (e.g., result set 282 of FIG. 2), the field placeholder can be replaced with the result field of the result set. Thus, the result set can be filtered using the abstract filter.

The requested value expression defines a value against which values of the at least one logical field that is represented by the field placeholder should be compared. The logical operator can be any suitable operator that defines an operation to be performed with respect to the requested value expression. In one embodiment, the logical operator is a comparison operator that defines a comparison operation, such as “equals”, “greater than” or “less than”, that is to be performed in order to identify the selected data elements that should be filtered. An other exemplary logical operator is a textual operator, such as “includes” or “similar to”. All such different implementations are broadly contemplated.

In one embodiment, the generic conditional statement is created by a user using the user interface that can be configured to display a graphical user interface for creation of the generic conditional statement. An exemplary graphical user interface is illustrated in FIG. 7.

An exemplary generic conditional statement is illustrated in Table III below. By way of example, the exemplary generic conditional statement is represented for purposes of illustration in a shorthand format without reference to any particular language. However, persons skilled in the art will readily recognize corresponding XML representations, such as used to describe the exemplary abstract query of Table I. Therefore, all possible different implementations are broadly contemplated.

### Tabke III-Generic Conditional Statement Example

### 001 Field ? is less than 25

The exemplary generic conditional statement of Table III is configured to filter values associated with a given logical field that are less than “25”. The given logical field is generically represented by the placeholder “?”.

At step 620, a filter name is created for the abstract filter. In one embodiment, the filter name is generated on the basis of user input received via the user interface, as illustrated in FIG. 7. By way of example, assume that in the given example the filter name “Low Value Filter” is created.

At step 630, a logical concept is created for the abstract filter. In one embodiment, the logical concept is generated on the basis of user input received via the user interface, as illustrated in FIG. 7. The logical concept describes a function and application area of the abstract filter. In other words, the logical concept describes a corresponding result set (e.g., filtered result set 270 of FIG. 2) with respect to the data elements that are discarded from output on the basis of the abstract filter. In this way, the logical concept provides a useful, abbreviated description of the filter that may help a user determine its utility in a given case. By way of example, assume that in the given example the logical concept “% Field?% is low” is created.

At step 640, the abstract filter is generated and method 600 exits. More specifically, the abstract filter is generated on the basis of the created generic conditional statement, the created filter name and the created logical concept. In one embodiment, the created abstract filter is stored as a persistent filter object. Thus, the abstract filter can be retrieved upon creation of abstract queries and/or for processing of query results, if required. In one embodiment, access to the created abstract filter can be restricted by attributing private or public access rights to the filter. For instance, if the abstract filter is declared “public”, all users may access and use the filter. If the filter is declared “private”, only the user who created the filter (or other users specifically identified in an authorized user field) may access and use it.

Referring now to FIG. 7, one embodiment of an exemplary graphical user interface (GUI) screen 700 for creation of an abstract filter (e.g., abstract filter 265 of FIG. 2) according to the method 600 of FIG. 6 is illustrated. The exemplary GUI screen 700 illustratively includes a display area 710 for creation of an abstract query (e.g., abstract query 260 of FIG. 2) that includes a plurality of displayable panels. By way of example, a panel 712 can be displayed for creation of query conditions (e.g., selection criteria 304 of FIG. 3B) and a panel 714 can be displayed for creation of a results specification (e.g., results specification 306 of FIG. 3B). Illustratively, a panel 720 is displayed for creation of a new abstract filter.

The panel 720 includes a text input field 730 for specification of a filter name according to step 620 of the method 600 of FIG. 6. In the given example, the filter name “Low Value Filter” was entered. As filter type, creation of a comparison filter was selected from a drop down menu 740, by way of example. More generally, the drop down menu 740 allows selection of multiple filter types, including the filter type “comparison filter”. However, in one embodiment any possible filter type can be selected from the menu 740. For instance, another selectable filter type can be an “existence filter” for filtering null values. Accordingly, any possible filter type is broadly contemplated. Furthermore, a checkbox 750 “Apply Filter Immediately” can be selected to indicate that the filter can be applied to an abstract query (as opposed to the result set of the executed query), as described in more detail below with reference to FIG. 9. In other words, if the checkbox 750 is not selected, the created abstract filter can only be applied to determined result sets (e.g., result set 282 of FIG. 2), in one embodiment.

The panel 720 further includes a display area 760 that is configured for specification of a generic conditional statement for the abstract filter according to step 610 of the method 600 of FIG. 6. Illustratively, the display area 760 includes an indication 766 of a field placeholder “?” for a logical field of an underlying data abstraction model (e.g., data abstraction model 292 of FIG. 2) to which the abstract filter can be applied. Furthermore, a requested comparison operator can be selected from a drop down menu 762. Illustratively, the comparison operator “Less Than” was selected. Finally, a requested comparison value expression for the generic conditional statement can be entered into a text field 764. Illustratively, the value “25” was entered. Accordingly, the exemplary generic conditional statement of Table III above was created.

The panel 720 further includes a text field 770 for entering a logical concept (also referred to herein as “logical descriptor”) according to step 630 of the method 600 of FIG. 6. Illustratively, the logical descriptor “% Field % is low” was entered.

By clicking a button 780 “Create”, the specified abstract filter is created and stored as a persistent filter object. Assume now that the button 780 is clicked. Accordingly, the abstract filter is created according to step 640 of the method 600 of FIG. 6, as described above. The abstract filter can thus be applied to a given abstract query (e.g., abstract query 260 of FIG. 2) or a result set (e.g., result set 282 of FIG. 2). Application of an abstract filter to an abstract query is described by way of example in more detail below with reference to FIGS. 9-11. Application of an abstract filter to a result set is described by way of example in more detail below with reference to FIG. 14.

### Using an Abstract Filter

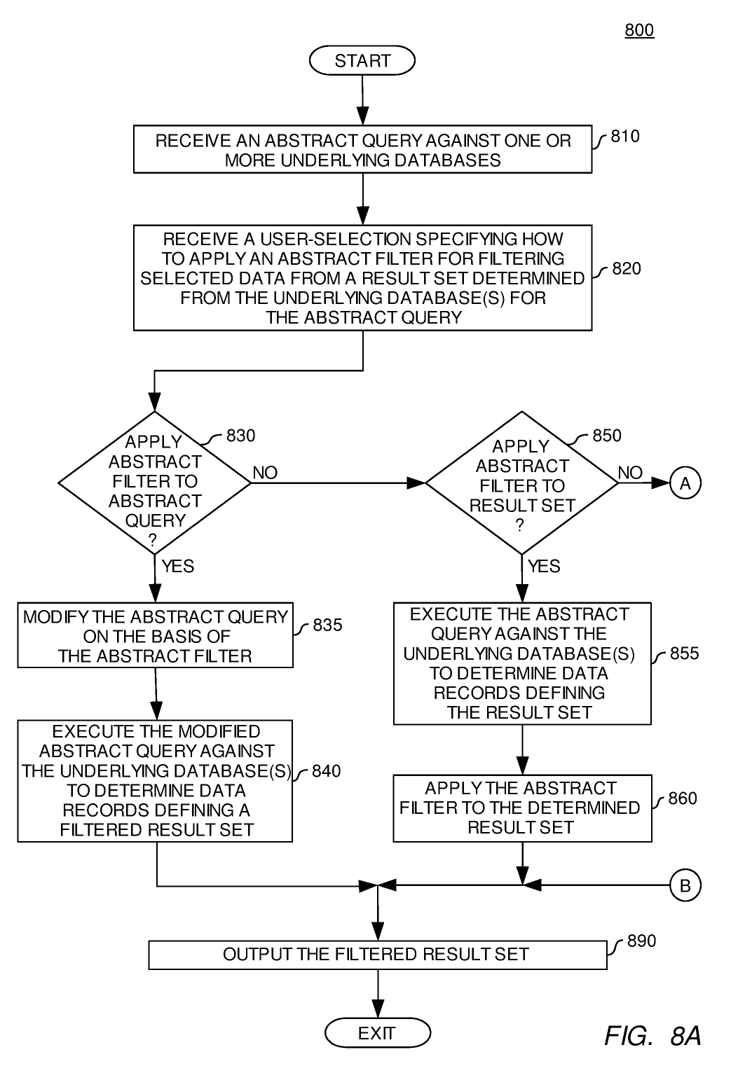

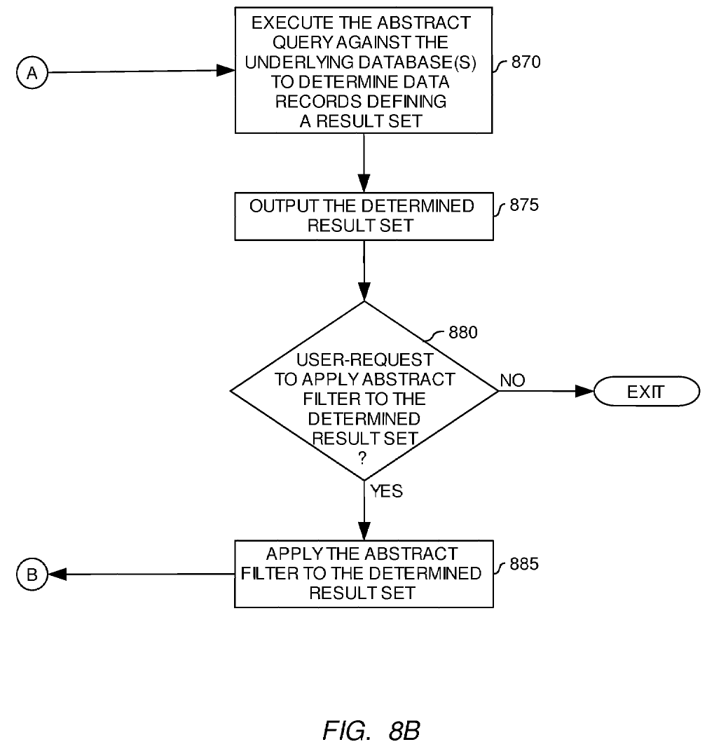

Referring now to FIGS. 8A-B, one embodiment of a method 800 for managing execution of an abstract query (e.g., abstract query 260 of FIG. 2) against an underlying database (e.g., database 230 of FIG. 2) is illustrated. At least a portion of the steps of method 800 can be performed using the user interface 210 of FIG. 2, the abstract model interface 290 of FIG. 2 and/or the query execution unit 236 of FIG. 2.

Method 800 starts at step 810, where an abstract query against one or more underlying databases is received. Assume now that the exemplary abstract query of Table IV below is received. By way of illustration, the illustrative abstract query is defined using XML. However, any other language may be used to advantage.

TABLE IV
ABSTRACT QUERY EXAMPLE

| | |
|---|---|
| 001 | <?xml version=“1.0”?> |
| 002 | <QueryAbstraction> |
| 003 | <Selection> |
| 004 | <Condition relOperator=“AND” fieldType=“char” |
| 005 | field=“data://Demographic/Gender” |
| | operator=“EQ” > |
| 006 | <Value val=“Female”/> |
| 007 | </Condition> |
| 008 | </Selection> |
| 009 | <Results format=“HTML” blockSize=“25” distinct=“Yes” |
| | mode=“Detail” > |
| 010 | <Field name=“data://Demographic/Patient ID” |
| 011 | fieldType=“int” groupByID=“0”/> |
| 012 | <Field name=“data://Demographic/Gender” |
| 013 | fieldType=“char” groupByID=“0”/> |
| 014 | <Field name=“data://Test/Hematology (coagulation) and |
| 015 | differential count/BLD/Hct % Bld” |
| 016 | fieldType=“float” groupByID=“0”/> |
| 017 | </Results> |
| 018 | <EntityRef name=“Patient”/> |
| 019 | </QueryAbstraction> |

The exemplary abstract query of Table IV is configured to retrieve information for particular patients from the underlying database(s). More specifically, the exemplary abstract query of Table IV illustratively includes three result fields in lines 010-016. Accordingly, data records having information related to patient identifiers (“Patient ID” in lines 010-011), gender (“Gender” in lines 012-013) and Hemoglobin test values (“Hct % Bld” in lines 014-016) is requested. However, in order to limit the number of returned data records from the underlying database(s), only data records for patients of the gender “female” (“Female” in lines 004-007) should be returned.

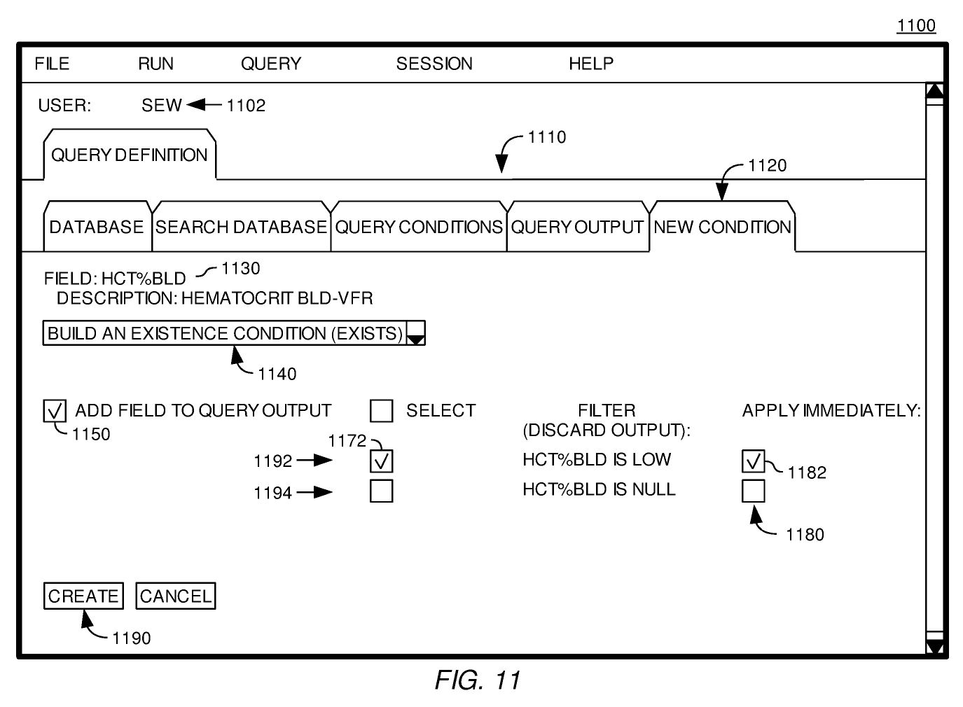

At step 820, a user-selection specifying how to apply a given abstract filter (e.g., abstract filter 265 of FIG. 2) to the received abstract query and/or a corresponding result set (e.g., result set 282 of FIG. 2) is received. At step 830, it is determined whether the given abstract filter should be applied to the received abstract query. If so, processing proceeds with step 835. Otherwise, processing continues at step 850. An exemplary GUI screen illustrating user-selection of application of an abstract filter to an abstract query is described in more detail below with reference to FIG. 11.

At step 835, the received abstract query is modified on the basis of the given abstract filter. In one embodiment, modifying the abstract query includes validating that the given abstract filter is applicable to the logical field definition of an underlying data abstraction model (e.g., data abstraction model 292 of FIG. 2) that is used in the abstract query. Accordingly, the abstract query is only modified if the validation is affirmative. However, it should be noted that a multiplicity of validation criteria can be specified which need to be satisfied for an affirmative validation of the given abstract filter. For instance, in one embodiment an underlying data type of values defined by the given abstract filter needs to match to a data type of values defined by the logical field definition of the underlying data abstraction model. Accordingly, any applicable validation criterion is broadly contemplated.

Assume now that the given abstract filter is configured to filter null values from a logical field of the underlying data abstraction model. Assume further that the given abstract filter should be applied to the “Hct % Bld” result field of the exemplary abstract query of Table IV. In other words, null values should be discarded from output in the “Hct % Bld” result field to obtain a filtered result set (e.g., filtered result set 270 of FIG. 2). Assuming that in the given example the given abstract filter is applicable to the “Hct % Bld” field, the validation is affirmative and the modification of the abstract query is performed.

In the given example, the modified abstract query of Table V below is obtained after application of the given abstract filter to the exemplary abstract query of Table IV above. By way of illustration, the illustrative abstract query is defined using XML. However, any other language may be used to advantage.

TABLE V
MODIFIED ABSTRACT QUERY EXAMPLE

| | |
|---|---|
| 001 | <?xml version=“1.0”?> |
| 002 | <QueryAbstraction> |
| 003 | <Selection> |
| 004 | <Condition relOperator=“AND” fieldType=“char” |
| 005 | field=“data://Demographic/Gender” |
| | operator=“EQ” > |
| 006 | <Value val=“Female”/> |
| 007 | </Condition> |
| 008 | <Condition relOperator=“AND” fieldType=“float” |
| 009 | field=“data://Test/Hematology (coagulation) and |
| 010 | differential count/BLD/Hct % Bld” |
| 011 | operator=“EXISTS” > |
| 012 | </Condition> |
| 013 | </Selection> |
| 014 | <Results format=“HTML” blockSize=“25” distinct=“Yes” |
| | mode=“Detail” > |
| 015 | <Field name=“data://Demographic/Patient ID” |
| | fieldType=“int” |
| 016 | groupByID=“0”/> |
| 017 | <Field name=“data://Demographic/Gender” |
| | fieldType=“char” |
| 018 | groupByID=“0”/> |
| 019 | <Field name=“data://Test/Hematology (coagulation) and |
| 020 | differential count/BLD/Hct % Bld” |
| | fieldType=“float” |
| 021 | groupByID=“0”/> |
| 022 | </Results> |
| 023 | <EntityRef name=“Patient”/> |
| 024 | </QueryAbstraction> |

The exemplary modified abstract query of Table V essentially corresponds to the exemplary abstract query of Table IV above. However, as can be seen from Table V, a new query condition was added in lines 008-012. This new query condition filters null values by restricting retrieved data records to data records having existing Hemoglobin test values (“Hct % Bld” in line 010, “EXISTS” in line 011).

At step 840, the modified abstract query is executed against the underlying database(s) to determine data records defining a filtered result set (e.g., filtered result set 270 of FIG. 2). In one embodiment, executing the modified abstract query includes transforming the modified abstract query into an executable query, such as an SQL or XML query, for execution. Transformation of the modified abstract query into a corresponding executable query can be performed using the methods 400 and 500 of FIGS. 4 and 5, respectively.

In the given example, the exemplary modified abstract query of Table V is transformed into the exemplary SQL query illustrated in Table VI below. By way of example, the query of Table VI below is defined using SQL. However, persons skilled in the art will readily recognize corresponding XML representations, such as used to describe the exemplary abstract query of Table I. Accordingly, it should be noted that implementation of the exemplary query of Table VI is not limited to a particular machine-readable language and that an implementation in any machine-readable language, known or unknown, is broadly contemplated.

TABLE VI
SQL QUERY EXAMPLE

| | |
|---|---|
| 001 | SELECT DISTINCT |
| 002 | “t1”.“PATIENT_ID” AS “Patient ID”, |
| 003 | db.mapgender( “t1”.“GENDER_ID” ) AS “Gender”, |
| 004 | “t2”.“Hct % Bld” AS “Hct % Bld” |
| 005 | FROM |
| 006 | “DB”.“PATIENTINFO” “t1” |
| 007 | LEFT JOIN ( |
| 008 | SELECT |
| 009 | DECIMAL(“t3”.“NUMERIC_VALUE”, 15, 3) AS |
| 010 | “Hct % Bld”, “t3”.“PATIENT_ID” |
| 011 | FROM |
| 012 | “DB”.“TESTRESULTS” “t3” |
| 013 | WHERE |
| 014 | “t3”.“LOINC_CODE” = ‘20570-8’ |
| 015 | ) |
| 016 | “t2” ON “t1”.“PATIENT_ID” = “t2”.“PATIENT_ID” |
| 017 | WHERE |
| 018 | ( ( “t1”.“GENDER_ID” = ‘F’ |
| 019 | AND “t2”.“Hct % Bld” IS NOT NULL ) |
| 020 | AND “t1”.“AUTHORIZATION_ID1” IS NULL ) |

The exemplary SQL query of Table VI includes in lines 002-004 the result fields of the exemplary abstract query of Table IV and the corresponding exemplary modified abstract query of Table V. The query condition related to the “Gender” field (lines 004-007 of Table IV and V) is included with line 018. Furthermore, in line 019 a query condition implementing the abstract filter for filtering null values from the “Hct % Bld” result field (line 004) is included. However, as SQL is well-known in the art, the exemplary query of Table VI is readily understood by persons skilled in the art and is, therefore, not explained in more detail.

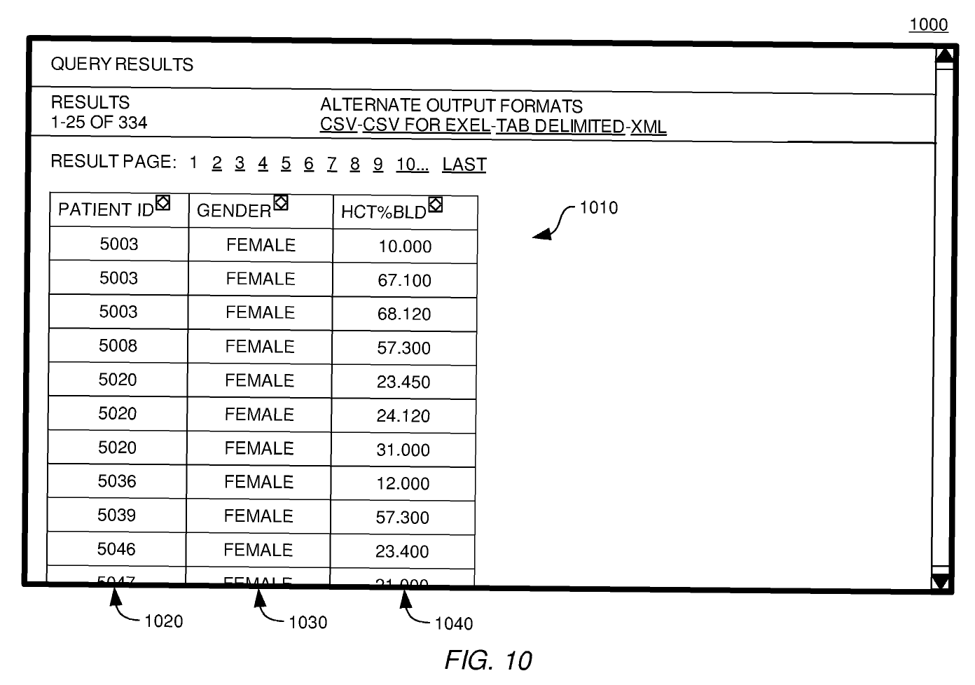

In response to execution of the exemplary SQL query of Table VI against the underlying database(s) at step 840, the filtered result set is obtained and output at step 890, where processing exits. An exemplary filtered result set is described in more detail below with reference to FIG. 10.

If, however, it is determined at step 830 that the given abstract filter should not be applied to the received abstract query, it is determined at step 850 whether the given abstract filter should be applied to an unfiltered result set (e.g., result set 282 of FIG. 2) which is determined in response to execution of the abstract query against the underlying database(s). If so, processing proceeds with step 855. Otherwise, processing continues at step 870 (FIG. 8B).

At step 855, the received abstract query is transformed into an executable query as described above and executed against the underlying database(s). In the given example, the exemplary abstract query of Table IV is transformed into the exemplary SQL query illustrated in Table VII below. Again, it should be noted that implementation of the exemplary query of Table VI is not limited to a particular machine-readable language and that an implementation in any machine-readable language, known or unknown, is broadly contemplated.

TABLE VII
SQL QUERY EXAMPLE

| | |
|---|---|
| 001 | SELECT DISTINCT |
| 002 | “t1”.“PATIENT_ID” AS “Patient ID”, |
| 003 | db.mapgender( “t1”.“GENDER_ID” ) AS “Gender”, |
| 004 | “t2”.“Hct % Bld” AS “Hct % Bld” |
| 005 | FROM |
| 006 | “DB”.“PATIENTINFO” “t1” |
| 007 | LEFT JOIN ( |
| 008 | SELECT |
| 009 | DECIMAL(“t3”.“NUMERIC_VALUE”, 15, 3) AS |
| 010 | “Hct % Bld”, “t3”.“PATIENT_ID” |
| 011 | FROM |
| 012 | “DB”.“TESTRESULTS” “t3” |
| 013 | WHERE |
| 014 | “t3”.“LOINC_CODE” = ‘20570-8’ |
| 015 | ) |
| 016 | “t2” ON “t1”.“PATIENT_ID” = “t2”.“PATIENT_ID” |
| 017 | WHERE |
| 018 | ( ( “t1”.“GENDER_ID” = ‘F’ |
| 019 | AND “t1”.“AUTHORIZATION_ID1” IS NULL ) |

The exemplary SQL query of Table VII corresponds to the exemplary SQL query of Table VI above, except the implementation of the abstract filter in line 019 of Table VI, which is missing in the exemplary SQL query of Table VII.

In response to execution of the exemplary SQL query of Table VII against the underlying database(s) at step 855, the unfiltered result set is obtained. An exemplary unfiltered result set is described in more detail below with reference to FIG. 9.

At step 860, the given abstract filter is applied to the unfiltered result set, whereby the filtered result set is determined, as described above. In the given example, the exemplary filtered result set illustrated in FIG. 10 is determined. This filtered result set is output at step 890.

If, however, it is determined at step 850 that the given abstract filter should not be applied to the unfiltered result set, the received abstract query is transformed into an executable query as described above with reference to step 855 and executed against the underlying database(s). In the given example, the exemplary abstract query of Table IV is transformed into the exemplary SQL query of Table VII, which is executed against the underlying database(s), whereby the exemplary unfiltered result set illustrated in FIG. 9 is determined.

At step 875, the unfiltered result set is output. For instance, the unfiltered result set is displayed to the user who issued the received abstract query of Table IV, in the given example. In one embodiment, displaying the unfiltered result set includes prompting the user to indicate whether the given abstract filter should be applied to the displayed unfiltered result set. An exemplary GUI screen illustrating user-selection of the given abstract filter for application to an unfiltered result set is described in more detail below with reference to FIG. 14.

At step 880, it is determined whether the given abstract filter should be applied to the displayed result set. More specifically, it is determined whether a corresponding user request was received. If so, processing proceeds with step 885. Otherwise, processing exits.

At step 885, the given abstract filter is applied to the displayed result set. In one embodiment, this is performed by applying the given abstract filter to the received abstract query as described above with reference to step 835. Alternatively, the displayed result set is parsed to filter selected data records on the basis of the given abstract filter. Thereby, the filtered result set is determined and output at step 890, as described above.

Referring now to FIG. 9, one embodiment of an exemplary GUI screen 900 illustrating a query result 910 is shown. The query result 910 exemplifies the unfiltered result set (e.g., result set 282 of FIG. 2) which is obtained in the given example in response to execution of the exemplary SQL query of Table VII against a corresponding underlying database. For simplicity, the underlying database is not described in more detail. As was noted above, the exemplary SQL query of Table VII is generated by transforming the exemplary abstract query of Table IV into a corresponding executable query without applying an abstract filter thereto.

The query result 910 includes a multiplicity of data records related to “Female” patients and includes data for three different result fields according to lines 002-004 of the exemplary SQL query of Table VII: a “Patient ID” result field 920, a “Gender” result field 930 and a “Hct % Bld” result field 940. However, the query result 910 includes a plurality of data records 950 and 960 having null values for the “Hct % Bld” result field 940. As was noted above, these null values can be filtered by applying a suitable abstract filter to the exemplary abstract query of Table IV, as described above with reference to Tables V and VI.

Referring now to FIG. 10, one embodiment of an exemplary GUI screen 1000 illustrating a query result 1010 is shown. The query result 1010 exemplifies the filtered result set (e.g., filtered result set 270 of FIG. 2) which can be obtained in the given example. More specifically, the query result 1010 is obtained in response to execution of the exemplary SQL query of Table VI against the underlying database used to obtain the query result 910 of FIG. 9, for purposes of illustration. As was noted above, the exemplary SQL query of Table VI is generated by transforming the exemplary abstract query of Table V into a corresponding executable query, after application of the abstract null filter thereto.

The query result 1010 also includes a multiplicity of data records related to “Female” patients and includes data for three different result fields according to lines 002-004 of the exemplary SQL query of Table VI: a “Patient ID” result field 1020, a “Gender” result field 1030 and a “Hct % Bld” result field 1040. However, it should be noted that in contrast to the query result 910 of FIG. 9, the query result 1010 does not include any null values for the “Hct % Bld” result field 1040. As was noted above with reference to Table VI, these null values are filtered using the abstract null filter implemented in line 019 of the exemplary SQL query of Table VI.

### Applying an Abstract Filter to a Query Condition Field

Referring now to FIG. 11, one embodiment of an exemplary GUI screen 1100 for application of an abstract filter (e.g., abstract filter 265 of FIG. 2) to a condition field of an abstract query (e.g., abstract query 260 of FIG. 2), as described above with reference to steps 830-835 of the method 800 of FIG. 8A, is illustrated. The exemplary GUI screen 1100 illustratively includes a display area 1110 for creation of an abstract query and includes a plurality of displayable panels. Illustratively, a panel 1120 is displayed for creation of a new query condition.

Assume now, that a logical field “Hct % Bld” was selected for creation of the new query condition. Accordingly, the panel 1120 includes an indication 1130 of the field name “Hct % Bld”.

Using a drop down menu 1140, a requested condition type can be selected. Illustratively, a selectable condition type for an “existence condition” is selected which can be used to restrict output for a given field to existing values such that null values are prevented from output. Another example for a condition type is a “comparison condition” for comparing an output value of a given field to a predetermined comparison value in order to determine whether a corresponding data record should be prevented from output. However, any possible condition type is broadly contemplated.

An exemplary abstract query having an existence condition for the “Hct % Bld” field is illustrated in Table VIII below. By way of illustration, the illustrative abstract query is defined using XML. However, any other language may be used to advantage.

TABLE VIII
ABSTRACT QUERY EXAMPLE

| | |
|---|---|
| 001 | <?xml version=“1.0”?> |
| 002 | <QueryAbstraction> |
| 003 | <Selection> |
| 004 | <Condition fieldType=“float” |
| 005 | field=“data://Test/Hematology (coagulation) and |
| 006 | differential count/Bld/Hct % Bld” |
| | operator=“EXISTS” > |
| 007 | </Condition> |
| 008 | </Selection> |
| 009 | <Results format=“HTML” blockSize=“25” distinct=“Yes” |
| | mode=“Detail” > |
| 010 | <Field name=“data://Demographic/Patient ID” |
| | fieldType=“int” |
| 011 | groupByID=“0”/> |
| 012 | <Field name=“data://Test/Hematology (coagulation) and |
| 013 | differential count/BLD/Hct % Bld” fieldType=“float” |
| 014 | groupByID=“0”/> |
| 015 | </Results> |
| 016 | <EntityRef name=“Patient”/> |
| 017 | </QueryAbstraction> |

The exemplary abstract query of Table VIII includes two result fields in lines 010-014. Accordingly, data records having information related to patient identifiers (“Patient ID” in lines 010-011) and Hemoglobin test values (“Hct % Bld” in lines 012-014) should be retrieved from an underlying database(s) (e.g., database 230 of FIG. 2). Illustratively, the “Hct % Bld” field was added to the result fields of the exemplary abstract query of Table VIII (lines 012-014) by selecting a checkbox 1150 “Add field to Query output” displayed in the panel 1120. In lines 004-006 of Table VIII, the existence condition on the “Hct % Bld” field is defined.

The panel 1120 further includes a display area 1104 that displays a list of available abstract filters to the user, who is identified by an illustrative user name 1102 as “SEW”. As was noted above, in the given example the displayed abstract filters may include publicly available filters and private filters of the user “SEW”. Illustratively, two abstract filters 1192 and 1194 are displayed. By way of example, assume that the filter 1192 is a private filter that was created by the user “SEW” using the exemplary GUI screen 700 of FIG. 7. Assume further that the filter 1194 is a public filter that was created by another user.

To allow user-selection of a suitable abstract filter, a list 1160 of logical descriptors for all available abstract filters is displayed. In one embodiment, if a given abstract filter does not have an associated logical descriptor, a filter name is used instead. Each logical descriptor is associated with a corresponding checkbox of a plurality of user-selectable checkboxes 1170 that allow user-selection of a requested abstract filter. Illustratively, a checkbox 1172 is selected for application of the abstract filter “Hct % Bld is low” to the existence condition on the “Hct % Bld” field. In other words, the user requests not only to exclude null values from output using the existence condition, but also to filter low Hemoglobin values that are less than 25.

Furthermore, a checkbox 1182 from a plurality of checkboxes 1180 “Apply Immediately” is selected to indicate that the selected abstract filter should be applied to the created abstract query prior to execution, as described above with reference to FIG. 9. By clicking a button 1190 “Create”, the specified abstract filter is applied to the condition field of the abstract query.

Assume now that the button 1190 is clicked in the given example. Accordingly, the exemplary abstract query of Table VIII is modified and the exemplary modified abstract query of Table IX below is obtained. By way of illustration, the illustrative abstract query is defined using XML. However, any other language may be used to advantage.

TABLE IX
MODIFIED ABSTRACT QUERY EXAMPLE

| | |
|---|---|
| 001 | <?xml version=“1.0”?> |
| 002 | <QueryAbstraction> |
| 003 | <Selection> |
| 004 | <Condition relOperator=“AND” fieldType=“float” |
| 005 | field=“data://Test/Hematology (coagulation) and |
| 006 | differential count/BLD/Hct % BlD” |
| 007 | operator=“EXISTS” > |
| 008 | </Condition> |
| 009 | <Condition relOperator=“AND” fieldType=“float” |
| 010 | field=“data://Test/Hematology (coagulation) and |
| 011 | differential count/BLD/Hct % Bld” operator=“LT” > |
| 012 | <Value val=”25”/> |
| 013 | </Condition> |
| 014 | </Selection> |
| 015 | <Results format=“HTML” blockSize=“25” distinct=“Yes” |
| | mode=“Detail” > |
| 016 | <Field name=“data://Demographic/Patient ID” |
| 017 | fieldType=“int” groupByID=“0”/> |
| 018 | <Field name=“data://Test/Hematology (coagulation) and |
| 019 | differential count/BLD/Hct % Bld” fieldType=“float” |
| 020 | groupByID=“0”/> |
| 021 | </Results> |
| 022 | <EntityRef name=“Patient”/> |
| 023 | </QueryAbstraction> |

The exemplary modified abstract query of Table IX essentially corresponds to the exemplary abstract query of Table VIII above. However, as can be seen from Table IX, a new query condition was added in lines 009-013. This new query condition filters Hemoglobin test values less than 25 (“Hct % Bld” and “LT” in line 011 and “25” in line 012).

As was noted above, in one embodiment the exemplary modified abstract query of Table IX is transformed into an executable or physical query for execution against the underlying database(s). However, for brevity a physical query corresponding to the exemplary modified abstract query of Table IX is not described in more detail.

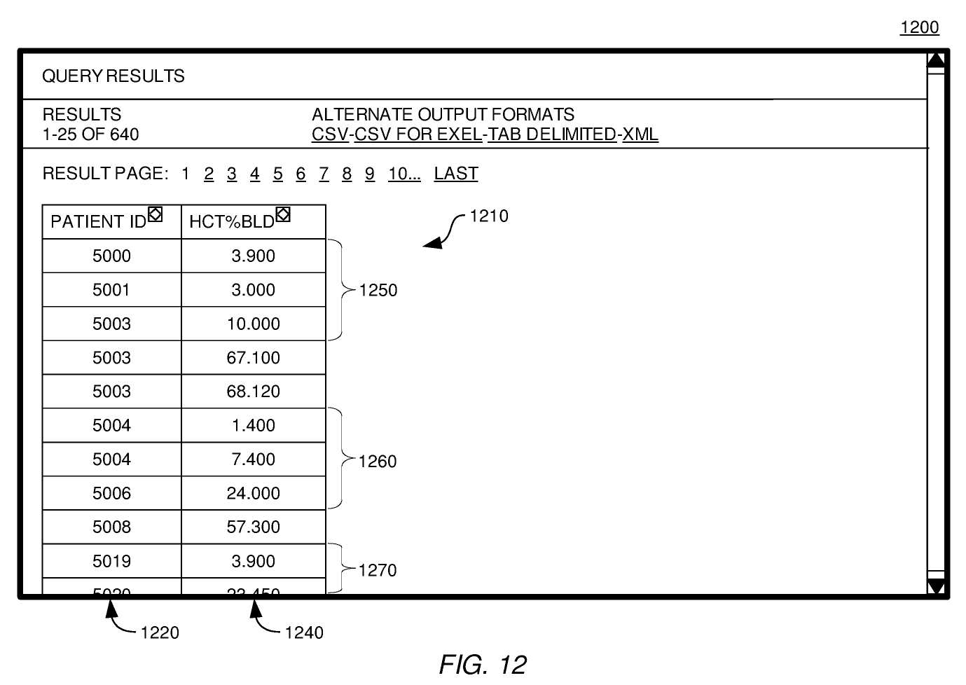

Referring now to FIG. 12, one embodiment of an exemplary GUI screen 1200 illustrating a query result 1210 is shown. Assume that the query result 1210 is obtained by executing the exemplary abstract query of Table VIII, i.e., a corresponding physical query against a corresponding underlying database(s). For simplicity and brevity, the underlying database(s) is not described in more detail. In other words, the query result 1210 represents an unfiltered result set (e.g., result set 282 of FIG. 2) which would be obtained using the exemplary abstract query of Table VIII without applying the “Hct % Bld is low” filter 1192 of FIG. 11 thereto.

The query result 1210 includes a multiplicity of data records for two different result fields according to lines 009-015 of the exemplary abstract query of Table VIII: a “Patient ID” result field 1220 and a “Hct % Bld” result field 1240. However, the query result 1210 includes a plurality of data records 1250, 1260 and 1270 having Hemoglobin test values for the “Hct % Bld” result field 1240 that are less than 25.

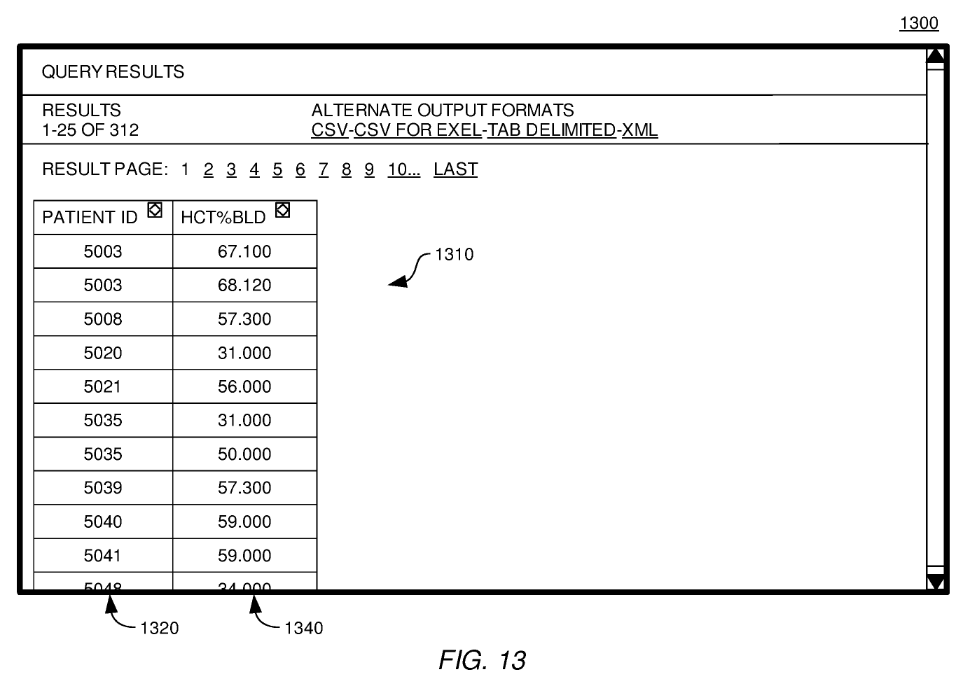

Referring now to FIG. 13, one embodiment of an exemplary GUI screen 1300 illustrating a query result 1310 is shown. The query result 1310 exemplifies a filtered result set (e.g., filtered result set 270 of FIG. 2) which can be obtained in the given example by filtering all low Hemoglobin test values from the exemplary query result 1210 of FIG. 12.

More specifically, the query result 1310 is obtained in response to execution of the exemplary modified abstract query of Table IX, i.e., a corresponding physical query against the underlying database used to obtain the query result 1210 of FIG. 12, for purposes of illustration. Accordingly, the query result 1310 also includes a “Patient ID” result field 1320 and a “Hct % Bld” result field 1340 (lines 015-021 of Table IX). However, it should be noted that in contrast to the query result 1210 of FIG. 12, the query result 1310 does not include Hemoglobin test values for the “Hct % Bld” result field 1340 that are less than 25. As was noted above with reference to Table IX, these low values are filtered using the abstract filter implemented in lines 009-013 of the exemplary modified abstract query of Table IX.

### Applying an Abstract Filter to a Query Result

Referring now to FIG. 14, one embodiment of an exemplary GUI screen 1400 for application of an abstract filter (e.g., abstract filter 265 of FIG. 2) to a displayed result set (e.g., result set 282 of FIG. 2), as described above with reference to steps 875-885 of the method 800 of FIG. 8B, is illustrated. The exemplary GUI screen 1400 illustratively includes a panel 1410 displaying the query result 1210 of FIG. 12, by way of example.

The panel 1410 further includes the display area 1104 of FIG. 11 allowing user-selection of an abstract filter for application to the result set 1210. Illustratively, the checkbox 1172 is selected to apply the abstract filter 1192 “Hct % Bld is low” to the query result 1210. By clicking a button 1450 “Filter”, the selected filter 1192 is applied to the query result. More specifically, the query result 1210 is parsed and all Hemoglobin test values that are less than 25 are removed from display of the “Hct % Bld” result field 1240, as described above with reference to FIG. 13.

In one embodiment, the checkbox 1182 “Apply Immediately” can optionally be selected, as illustrated in FIG. 14. If this checkbox 1182 is selected, the selected abstract filter 1192 is applied to a corresponding underlying abstract query (e.g., abstract query 260 of FIG. 2). In other words, in the given example, the exemplary abstract query of Table VIII is retrieved and modified on the basis of the selected abstract filter 1192, whereby the exemplary modified abstract query of Table IX is obtained. As noted above, the exemplary modified abstract query of Table IX is then transformed into a physical query that is executed against the underlying database(s), whereby the filtered query result 1310 of FIG. 13 is obtained. The filtered result set is subsequently displayed in the panel 1410.

While the foregoing is directed to embodiments of the present invention, other and further embodiments of the invention may be devised without departing from the basic scope thereof, and the scope thereof is determined by the claims that follow.

What is claimed is:

1. A computer-implemented method of managing execution of an abstract query against an underlying database, comprising:
receiving an abstract query against one or more databases having physical data, the abstract query being defined using logical field definitions defined in an abstraction model that models the physical data in a manner making a schema of the physical data transparent to a user of the abstraction model;
receiving a user-selection specifying how to apply an abstract filter for filtering data;
if the received user-selection specifies application of the abstract filter to an obtained result set:
executing the abstract query to determine a first result set containing data from the one or more databases; and
filtering the determined first result set on the basis of the abstract filter,
whereby selected data is discarded from the first result set; and
if the received user-selection specifies application of the abstract filter to the abstract query:
modifying the abstract query on the basis of the abstract filter; and
executing the modified abstract query to determine a second result set containing data from the one or more databases.

2. The method of claim 1, wherein the abstract filter comprises a generic conditional statement associating a parameterized logical field definition with a logical operator and a comparison value, the parameterized logical field definition defining a field placeholder for a logical field definition from the abstraction model that is used to define the abstract query and/or a result field of the determined first result set.

3. The method of claim 2, wherein the abstract filter is uniquely identified by an associated filter name and associated with a logical concept describing function and application area of the abstract filter.

4. The method of claim 2, wherein the logical operator is one of a comparison operator and a textual operator.

5. The method of claim 1, wherein the abstract query includes at least one result field for which data from the one or more databases is to be retrieved, the at least one result field corresponding to a logical field definition of the abstraction model; and wherein modifying the abstract query comprises:
applying the abstract filter to the at least one result field to generate the modified abstract query.

6. The method of claim 5, wherein the abstract filter is defined using a field placeholder applicable to at least a portion of the logical field definitions of the abstraction model, the method further comprising:
prior to applying the abstract filter to the at least one result field, validating that the abstract filter is applicable to the logical field definition of the abstraction model which corresponds to the at least one result field; and
applying the abstract filter to the at least one result field only if the validation is affirmative.

7. The method of claim 5, wherein the abstract query includes at least one query condition defined for determining which of the physical data contained in the one or more databases is returned for the at least one result field, wherein the at least one query condition is defined using a condition field corresponding to a logical field definition of the abstraction model; and wherein modifying the abstract query comprises:
applying the abstract filter to the condition field.

8. The method of claim 1, wherein the abstraction model is configured for transforming the abstract query and the modified abstract query into a form consistent with a physical representation of the physical data in the one or more databases, and wherein executing one of the abstract query and the modified abstract query against the one or more databases comprises:
transforming the query into an executable query capable of being executed against the physical data in the one or more databases; and
executing the executable query against the one or more databases to obtain one of the first and second result sets.

9. The method of claim 1, further comprising:
if the received user-selection does not specify application of the abstract filter to the abstract query and/or the obtained result set:
executing the abstract query against the one or more databases to determine the first result set;
displaying the determined first result set to a user; and
prompting the user for user-selection specifying whether the displayed first result set is to be filtered on the basis of the abstract filter.

10. A computer-implemented method of managing execution of an abstract query against an underlying database, comprising:
receiving an abstract query against one or more databases having physical data, the abstract query being defined using logical field definitions defined in an abstraction model that models the physical data in a manner making a schema of the physical data transparent to a user of the abstraction model;
receiving a user-selection specifying how to apply an abstract filter for filtering data; and
if the received user-selection specifies application of the abstract filter to the abstract query:
submitting the abstract query to a runtime unit configured to (i) modify the abstract query on the basis of the abstract filter; and (ii) transform the modified abstract query into a first physical query suitable for execution against the one or more databases to determine a first result set; and
as a result of executing the first physical query, receiving the first result set containing data from the one or more databases.

11. The method of claim 10, further comprising:
if the received user-selection specifies application of the abstract filter to an obtained result set:
submitting the abstract query to a runtime unit configured to transform the abstract query into a second physical query suitable for execution against the one or more databases to determine a second result set;
as a result of executing the second physical query, receiving the second result set containing data from the one or more databases; and
filtering the received second result set on the basis of the abstract filter, whereby selected data is discarded from the second result set.

12. A computer-implemented method of creating an abstract filter, comprising:
creating a generic conditional statement associating a parameterized logical field definition with a logical operator and a comparison value, the parameterized logical field definition defining a field placeholder for a logical field definition defined in an abstraction model that models underlying physical data in a manner making a schema of the physical data transparent to a user of the abstraction model;
associating a filter name with the abstract filter that uniquely identifies the abstract filter; and
storing the generic conditional statement as the abstract filter using the filter name.

13. A computer-readable medium containing a program which, when executed by a processor, performs a process for managing execution of an abstract query against an underlying database, the process comprising:
receiving an abstract query against one or more databases having physical data, the abstract query being defined using logical field definitions defined in an abstraction model that models the physical data in a manner making a schema of the physical data transparent to a user of the abstraction model;
receiving a user-selection specifying how to apply an abstract filter for filtering data;
if the received user-selection specifies application of the abstract filter to an obtained result set:
executing the abstract query to determine a first result set containing data from the one or more databases; and
filtering the determined first result set on the basis of the abstract filter, whereby selected data is discarded from the first result set; and
if the received user-selection specifies application of the abstract filter to the abstract query:
modifying the abstract query on the basis of the abstract filter; and
executing the modified abstract query to determine a second result set containing data from the one or more databases.

14. The computer-readable medium of claim 13, wherein the abstract filter comprises a generic conditional statement associating a parameterized logical field definition with a logical operator and a comparison value, the parameterized logical field definition defining a field placeholder for a logical field definition from the abstraction model that is used to define the abstract query and/or a result field of the determined first result set.

15. The computer-readable medium of claim 14, wherein the abstract filter is uniquely identified by an associated filter name and associated with a logical concept describing function and application area of the abstract filter.

16. The computer-readable medium of claim 14, wherein the logical operator is one of a comparison operator and a textual operator.

17. The computer-readable medium of claim 13, wherein the abstract query includes at least one result field for which data from the one or more databases is to be retrieved, the at least one result field corresponding to a logical field definition of the abstraction model; and wherein modifying the abstract query comprises:
applying the abstract filter to the at least one result field to generate the modified abstract query.

18. The computer-readable medium of claim 17, wherein the abstract filter is defined using a field placeholder applicable to at least a portion of the logical field definitions of the abstraction model, the method further comprising:
prior to applying the abstract filter to the at least one result field, validating that the abstract filter is applicable to the logical field definition of the abstraction model which corresponds to the at least one result field; and
applying the abstract filter to the at least one result field only if the validation is affirmative.

19. The computer-readable medium of claim 17, wherein the abstract query includes at least one query condition defined for determining which of the physical data contained in the one or more databases is returned for the at least one result field, wherein the at least one query condition is defined using a condition field corresponding to a logical field definition of the abstraction model; and wherein modifying the abstract query comprises:
applying the abstract filter to the condition field.

20. The computer-readable medium of claim 13, wherein the abstraction model is configured for transforming the abstract query and the modified abstract query into a form consistent with a physical representation of the physical data in the one or more databases, and wherein executing one of the abstract query and the modified abstract query against the one or more databases comprises:
transforming the query into an executable query capable of being executed against the physical data in the one or more databases; and
executing the executable query against the one or more databases to obtain one of the first and second result sets.

21. The computer-readable medium of claim 13, wherein the process further comprises:
if the received user-selection does not specify application of the abstract filter to the abstract query and/or the obtained result set:
executing the abstract query against the one or more databases to determine the first result set;
displaying the determined first result set to a user; and
prompting the user for user-selection specifying whether the displayed first result set is to be filtered on the basis of the abstract filter.

22. A computer-readable medium containing a program which, when executed by a processor, performs a process for managing execution of an abstract query against an underlying database, the process comprising:
receiving an abstract query against one or more databases having physical data, the abstract query being defined using logical field definitions defined in an abstraction model that models the physical data in a manner making a schema of the physical data transparent to a user of the abstraction model;
receiving a user-selection specifying how to apply an abstract filter for filtering data; and
if the received user-selection specifies application of the abstract filter to the abstract query:
submitting the abstract query to a runtime unit configured to (i) modify the abstract query on the basis of the abstract filter; and (ii) transform the modified abstract query into a first physical query suitable for execution against the one or more databases to determine a first result set; and
as a result of executing the first physical query, receiving the first result set containing data from the one or more databases.

23. The computer-readable medium of claim 22, wherein the process further comprises:
if the received user-selection specifies application of the abstract filter to an obtained result set:
submitting the abstract query to a runtime unit configured to transform the abstract query into a second physical query suitable for execution against the one or more databases to determine a second result set;
as a result of executing the second physical query, receiving the second result set containing data from the one or more databases; and
filtering the received second result set on the basis of the abstract filter, whereby selected data is discarded from the second result set.

24. A computer-readable medium containing a program which, when executed by a processor, performs a process for creating an abstract filter, the process comprising:
creating a generic conditional statement associating a parameterized logical field definition with a logical operator and a comparison value, the parameterized logical field definition defining a field placeholder for a logical field definition defined in an abstraction model that models underlying physical data in a manner making a schema of the physical data transparent to a user of the abstraction model;
associating a filter name with the abstract filter that uniquely identifies the abstract filter; and
storing the generic conditional statement as the abstract filter using the filter name.
